(19) United States
(12) Patent Application Publication
(10) Pub. No.: US 2026/0110955 A1
(43) Pub. Date: Apr. 23, 2026

(54) WAVELENGTH CONVERTER, LIGHT SOURCE DEVICE, AND PROJECTOR

(71) Applicant: SEIKO EPSON CORPORATION, Tokyo (JP)

(72) Inventor: Satoshi KITO, CHINO-SHI (JP)

(21) Appl. No.: 19/364,524

(22) Filed: Oct. 21, 2025

(30) Foreign Application Priority Data
Oct. 22, 2024 (JP) 2024-185804

(51) Int. Cl. G03B 21/20

(52) U.S. Cl. CPC G03B 21/204; G03B 21/2066

(57) ABSTRACT

A wavelength converter, according to the present disclosure, includes a substrate; a phosphor layer disposed on a substrate and configured to convert incident first light in a first wavelength band into second light in a second wavelength band different from the first wavelength band; a reflective layer arranged between the phosphor layer and the substrate and configured to reflect the first light and the second light; and an auxiliary light-emitting layer that is arranged between the phosphor layer and the reflective layer, that includes a plurality of quantum dots, and that is configured to convert a portion of the first light transmitted through the phosphor layer and a portion of the second light converted by the phosphor layer into third light in a third wavelength band that is different from the first wavelength band and that partially overlaps the second wavelength band, wherein the auxiliary light-emitting layer has a planar size larger than a planar size of the phosphor layer and the entire phosphor layer overlaps the auxiliary light-emitting layer as viewed in plan view from a normal direction of the substrate.

The present application is based on, and claims priority from JP Application Serial Number 2024-185804, filed October 22, 2024, the disclosure of which is hereby incorporated by reference herein in its entirety.

### BACKGROUND

### 1. Technical Field

The present disclosure relates to a wavelength converter, a light source device, and a projector.

### 2. Related Art

In recent years, as a light source device used in a projector, there is a technique of exciting a phosphor layer with blue light emitted from a lighting source and combining yellow fluorescence generated in the phosphor layer and the blue light not used for excitation in the phosphor layer to generate white illumination light (for example, see JP-A-2015-197620).

However, in the light source device described above, since the excitation light from the lighting source is incident on the phosphor layer in a condensed state, there is a problem that the fluorescence conversion efficiency decreases for a phosphor layer having a high temperature, so that the emission amount of the fluorescence decreases. Since the red component contained in the yellow fluorescence is generally small, there is also a problem that the color gamut of the illumination light emitted from the light source device is narrow and the quality of the image projected by the projector is low.

### SUMMARY

In order to solve the above problem, a wavelength converter, according to one aspect of the present disclosure, includes a substrate; a phosphor layer arranged on the substrate and configured to convert incident first light in a first wavelength band into second light in a second wavelength band that is different from the first wavelength band; a reflective layer arranged between the phosphor layer and the substrate and configured to reflect the first light and the second light; and an auxiliary light-emitting layer that is arranged between the phosphor layer and the reflective layer, that includes a plurality of quantum dots, and that is configured to convert a portion of the first light transmitted through the phosphor layer and a portion of the second light converted by the phosphor layer into third light in a third wavelength band that is different from the first wavelength band and that partially overlaps the second wavelength band, wherein the auxiliary light-emitting layer has a planar size larger than a planar size of the phosphor layer, and in a plan view from a normal direction of the substrate, the entire phosphor layer overlaps the auxiliary light-emitting layer.

According to another aspect of the disclosure, there is provided a light source device including the wavelength converter according to the aspect of the disclosure, and a lighting source configured to emit the first light toward the wavelength converter.

According to another aspect of the disclosure, there is provided a projector including the light source device according to the aspect of the disclosure, a light modulation device that modulates scanning light emitted from the light scanning section in accordance with image information, and a projection optical device that projects image light emitted from the light modulation device.

### BRIEF DESCRIPTION OF THE DRAWINGS

FIG. 1 is a schematic configuration diagram showing a projector according to a first embodiment.

FIG. 2 is a schematic configuration diagram showing the light source device 2 according to the embodiment.

FIG. 3 is a cross-sectional view illustrating a configuration of the wavelength converter 50.

FIG. 4 is a graph showing temperature characteristics of conversion efficiency of a phosphor layer and a quantum dot layer.

FIG. 5 is a graph showing the temperature conditions of the phosphor layer and the auxiliary light-emitting layer.

FIG. 6 is a plan view of the wavelength converter.

FIG. 7 is a graph showing an emission spectrum of fluorescence emitted by the wavelength converter.

FIG. 8A is a diagram illustrating a cross-sectional structure of a wavelength converter according to a modification.

FIG. 8B is a diagram illustrating a cross-sectional structure of a wavelength converter according to a modification.

### DESCRIPTION OF EMBODIMENTS

### FIRST EMBODIMENT

Hereinafter, an embodiment of the present disclosure will be described.

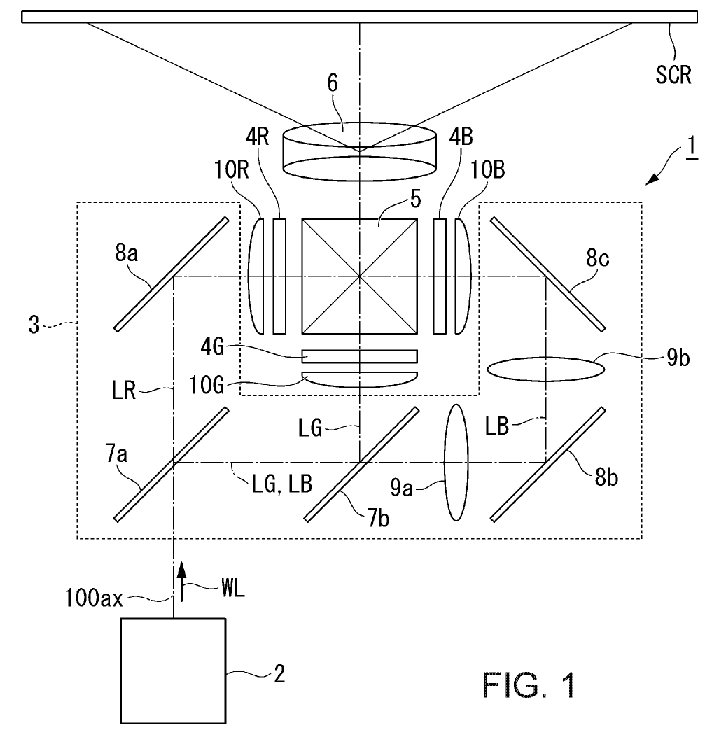

FIG. 1 is a schematic configuration diagram showing a projector according to a first embodiment.

As shown in FIG. 1, a projector 1 of the present embodiment is a projection-type image display device that displays an image on a screen SCR. The projector 1 includes a light source device 2, a color separation optical system 3, a light modulation device 4R, a light modulation device 4G, a light modulation device 4B, a combining optical system 5, and a projection optical device 6.

The light source device 2 emits white illumination light WL toward the color separation optical system 3. The configuration of the light source device 2 will be described later in detail.

The color separation optical system 3 separates the illumination light WL outputted from the light source device 2 into red light LR, green light LG, and blue light LB. The color separation optical system 3 includes a first dichroic mirror 7a, a second dichroic mirror 7b, a first total internal reflection mirror 8a, a second total internal reflection mirror 8b, a third total internal reflection mirror 8c, a first relay lens 9a, and a second relay lens 9b.

The first dichroic mirror 7a separates the illumination light WL from the light source device 2 into the red light LR and light including the green light LG and the blue light LB. The first dichroic mirror 7a transmits the red light LR and reflects the light including the green light LG and the blue light LB. On the other hand, the second dichroic mirror 7b reflects the green light LG and transmits the blue light LB. The second dichroic mirror 7b thus separates the light containing the green light LG and the blue light LB into the green light LG and the blue light LB.

The first total internal reflection mirror 8a is arranged in the optical path of the red light LR, and reflects the red light LR transmitted through the first dichroic mirror 7a toward the light modulation device 4R. On the other hand, the second total internal reflection mirror 8b and the third total internal reflection mirror 8c are arranged in the light path of the blue light LB, and guide the blue light LB transmitted through the second dichroic mirror 7b to the light modulation device 4B. The green light LG is reflected off the second dichroic mirror 7b toward the light modulation device 4G.

The first relay lens 9a is arranged between the second dichroic mirror 7b and the second total internal reflection mirror 8b in the optical path of the blue light LB. The second relay lens 9b is arranged between the second total internal reflection mirror 8b and the third total internal reflection mirror 8c in the optical path of the blue light LB. The first relay lens 9a and the second relay lens 9b compensate for the light loss of the blue light LB caused by the fact that the optical path length of the blue light LB is longer than the optical path length of the red light LR or the green light LG.

The light modulation device 4R modulates the red light LR in accordance with image information to form image light corresponding to the red light LR. The light modulation device 4G modulates the green light LG in accordance with image information to form image light corresponding to the green light LG. The light modulation device 4B modulates the blue light LB in accordance with image information to form image light corresponding to the blue light LB.

Transmissive liquid crystal panels, for example, are used as the light modulation devices 4R, 4G, and 4B. Polarizing plates (not shown) are arranged on the incident side and the emission side of the liquid crystal panel.

A field lens 10R is arranged on the incident side of the light modulation device 4R. The field lens 10R parallelizes the red light LR incident on the light modulation device 4R. A field lens 10G is arranged on the incident side of the light modulation device 4G. The field lens 10G parallelizes the green light LG incident on the light modulation device 4G. A field lens 10B is arranged on the incident side of the light modulation device 4B. The field lens 10B parallelizes the blue light LB incident on the light modulation device 4B.

The image light emitted from the light modulation device 4R, the light modulation device 4G, and the light modulation device 4B enters the combining optical system 5. The combining optical system 5 combines the image light fluxes corresponding to the red light LR, the green light LG, and the blue light LB with one another and outputs the combined image light toward the projection optical device 6. The combining optical system 5 includes, for example, a cross dichroic prism.

The projection optical device 6 has a plurality of projection lenses. The projection optical device 6 enlarges and projects the image light combined by the combining optical system 5 toward the screen SCR. Thus, an enlarged image is displayed on the screen SCR.

The configuration of the light source device 2 will be described below.

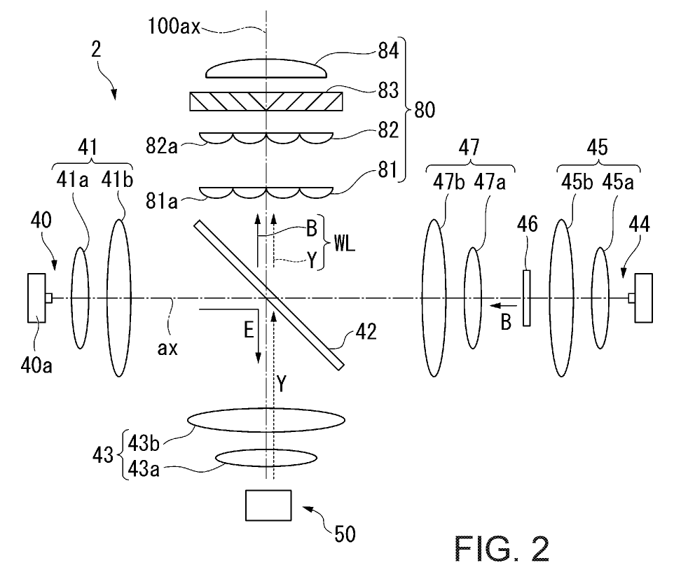

FIG. 2 is a schematic configuration diagram showing the light source device 2 according to the present embodiment.

As shown in FIG. 2, the light source device 2 includes a first light source 40, a collimate optical system 41, a dichroic mirror 42, a first condensing optical system 43, a wavelength converter 50, a second light source 44, a second condensing optical system 45, a diffusion plate 46, and a collimate optical system 47.

The first light source 40 emits excitation light E formed of laser light toward the wavelength converter 50. The excitation light E is blue light in a first wavelength band. The first wavelength band is, for example, 455 ± 10 nm. The excitation light E in the present embodiment corresponds to an example of “first light in a first wavelength band” in the present disclosure.

The first light source 40 is formed of a laser diode 40a that emits the excitation light E. The number laser diodes 40a constituting the first light source 40 may be one or more. The laser diode 40a may be a laser diode that emits light having wavelengths other than 445nm, such as blue light of 455nm or 460nm. The optical axis ax of the first light source 40 is orthogonal to the illumination optical axis 100ax of the light source device 2. The first light source 40 of the present embodiment corresponds to an example of the “lighting source” of the present disclosure.

The collimate optical system 41 includes a lens 41a and a lens 41b. The collimate optical system 41 substantially parallelizes the light outputted from the first light source 40. Each of the lens 41a and the lens 41b is formed of a convex lens.

The dichroic mirror 42 is arranged in the optical path from the collimate optical system 41 to the first condensing optical system 43 in a direction intersecting the optical axis ax of the first light sources 40 and the illumination optical axis 100ax at an angle of 45°. The dichroic mirror 42 reflects the blue light component and transmits the red light component and the green light component. The dichroic mirror 42 therefore reflects the excitation light E and the blue light B and transmits the yellow fluorescence Y.

The first condensing optical system 43 collects the excitation light E having passed through the dichroic mirror 42 and causes the collected excitation light E to enter the wavelength converter 50, and substantially parallelizes the fluorescence Y emitted from the wavelength converter 50. The first condensing optical system 43 includes a lens 43a and a lens 43b. Each of the lens 43a and the lens 43b is formed of a convex lens.

The second light source 44 is constituted by a laser diode having the same wavelength band as the wavelength band of the first light source 40. The second light source 44 may be constituted by one laser diode or may be constituted by a plurality of laser diodes. The second light source 44 may be formed of a laser diode having a wavelength band different from that of the laser diode of the first light source 40.

The second condensing optical system 45 includes a lens 45a and a lens 45b. The second condensing optical system 45 collects the blue light B outputted from the second light source 44 on a diffusion surface of the diffusion plate 46 or in the vicinity of the diffusion surface. Each of the lens 45a and the lens 45b is formed of a convex lens.

The diffusion plate 46 diffuses the blue light B outputted from the second light source 44 to generate the blue light B having a light orientation distribution close to the light orientation distribution of the fluorescence Y outputted from the wavelength converter 50. As the diffusion plate 46, for example, frosted glass made of optical glass can be used.

The collimate optical system 47 includes a lens 47a and a lens 47b. The collimate optical system 47 substantially parallelizes the light outputted from the diffusion plate 46. Each of the lens 47a and the lens 47b is formed of a convex lens.

The blue light B outputted from the second light source 44 is reflected off the dichroic mirror 42 and combined with the fluorescence Y having exited out of the wavelength converter 50 and having passed through the dichroic mirror 42 to produce white illumination light WL. The illumination light WL enters a uniform illumination optical system 80.

The uniform illumination optical system 80 includes a first lens array 81, a second lens array 82, a polarization conversion element 83, and a superimposing lens 84.

The first lens array 81 has a plurality of first lenses 81a for dividing the illumination light WL from the light source device 2 into a plurality of partial light fluxes. The plurality of first lenses 81a are arranged in a matrix in a plane perpendicular to the illumination optical axis 100ax.

The second lens array 82 has a plurality of second lenses 82a corresponding to the plurality of first lenses 81a of the first lens array 81. The plurality of second lenses 82a are arranged in a matrix in a plane perpendicular to the illumination optical axis 100ax.

Together with the superimposing lens 84, the second lens array 82 forms images of each of the first lenses 81a of the first lens array 81 in the vicinity of image formation regions of the light modulation device 4R, the light modulation device 4G, and the light modulation device 4B, respectively.

The polarization conversion element 83 converts the light emitted from the second lens array 82 into unidirectional linearly polarized light. The polarization conversion element 83 includes, for example, a polarization separation film and a retardation board (not shown).

The superimposing lens 84 condenses partial beams emitted from the polarization conversion element 83 and superimposes them in the vicinity of an image formation region of the light modulation device 4R, the light modulation device 4G, and the light modulation device 4B.

Next, the configuration of the wavelength converter 50 will be described.

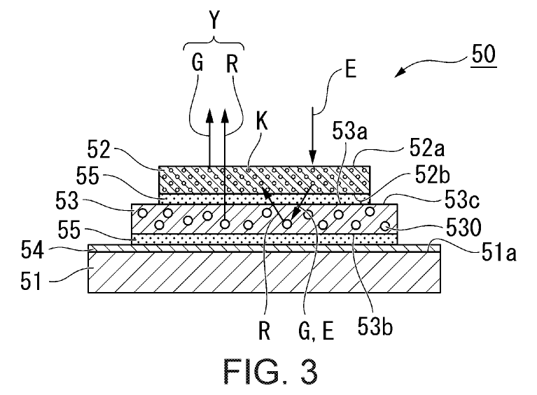

FIG. 3 is a cross-sectional view illustrating a configuration of the wavelength converter 50. FIG. 3 corresponds to a cross-section of the wavelength converter 50 taken along a plane including the illumination optical axis 100ax in FIG. 2.

As shown in FIG. 3, the wavelength converter 50 includes a substrate 51, a phosphor layer 52, an auxiliary light-emitting layer 53, and a reflective layer 54. The wavelength converter 50 in the present embodiment is formed of a fixed wavelength converter in which the position where the excitation light E is incident on the phosphor layer 52 does not change with time.

The substrate 51 is made of a metallic material having high thermal conductivity, such as aluminum or copper, and has a support surface 51a that supports the reflective layer 54, the auxiliary light-emitting layer 53, and the phosphor layer 52. The substrate 51 has a function as a heat dissipation plate that dissipates heat of the reflective layer 54, the auxiliary light-emitting layer 53, and the phosphor layer 52.

The phosphor layer 52 is a green light emitting phosphor that absorbs the excitation light E, converts the excitation light E into fluorescence G, and emits the fluorescence G. In other words, the phosphor layer 52 converts the excitation light E incident from the first light source 40 into the fluorescence G in a second wavelength band that is different from the blue wavelength band, and then emits the fluorescence G. The second wavelength band is, for example, 500 to 630 nm. That is, the excitation light E is converted into the fluorescence G containing a large amount of green component in the phosphor layer 52. The fluorescence G in the present embodiment corresponds to an example of “second light in a second wavelength band” in the present disclosure.

The phosphor layer 52 of the present embodiment is formed of a ceramic phosphor containing, for example, a LuAG (Lu₃Al₅O₁₂) - based phosphor as a green light emitting phosphor.

The phosphor layer 52 of the present embodiment includes a plurality of voids K. The plurality of voids K function as scatterers in the phosphor layer 52. The content of the voids K is 3 vol% or less in terms of volume percentage with respect to the entire phosphor layer 52. According to this configuration, since the light is appropriately scattered inside the phosphor layer 52, it is possible to suppress the expansion of the light emitting area of the phosphor layer 52 due to the excessive spread of the light in the plane direction inside the phosphor layer 52. Therefore, it is possible to reduce the etendue of the light emitted from the phosphor layer 52, and it is possible to reduce the light loss in the optical components such as the uniform illumination optical system 80 arranged in the subsequent stage of the phosphor layer 52.

The fluorescence conversion efficiency of the phosphor layer 52 varies depending on the thickness and the cerium ion concentration thereof. That is, the light amount of the excitation light E that passes through the phosphor layer 52 and reaches the auxiliary light-emitting layer 53 changes depending on the thickness and the cerium ion concentration of the phosphor layer 52 as described later.

In the present embodiment, the thickness of the phosphor layer 52 is 200 μm or less, and the concentration of ceric ion of Ce as an activator in the phosphor layer 52 is set to 1 mol% or less. According to this configuration, a sufficient amount of the excitation light E can be incident on the auxiliary light-emitting layer 53.

The auxiliary light-emitting layer 53 is arranged between the phosphor layer 52 and the substrate 51. The auxiliary light-emitting layer 53 of the present embodiment is bonded to the reflective layer 54 and the phosphor layer 52 via an adhesive layer 55. Therefore, the adhesive layer 55 bonds a front face 53a of the auxiliary light-emitting layer 53 with the phosphor layer 52, and bonds a rear face 53b of the auxiliary light-emitting layer 53 to the reflective layer 54.

The auxiliary light-emitting layer 53 of the present embodiment is formed in a film shape including a plurality of quantum dots 530. Each quantum dot 530 is, for example, a particle of a compound semiconductor (for example, GaAs, GaN, or the like) having a size of several nanometers to several tens of nanometers. In general, the quantum dots 530 have a wavelength conversion function of emitting light of another color when irradiated with light. The quantum dots 530 have different wavelength conversion functions depending on their sizes. In other words, the quantum dots 530 generate fluorescence of a color corresponding to the size. In the case of using such a film-shaped auxiliary light-emitting layer 53, the auxiliary light-emitting layer 53 can be manufactured by being attached to the substrate 51 and the phosphor layer 52 by the adhesive layer 55. Therefore, the wavelength converter 50 can be easily manufactured.

The auxiliary light-emitting layer 53 in the present embodiment mainly converts the excitation light E incident from the phosphor layer 52 into and emits fluorescence R in a third wavelength band that is different from the first wavelength band and that also overlaps part of the second wavelength band. The fluorescence R in the third wavelength band is in the range of 600 to 700 nm, and is, for example, red light having a peak in 630 nm. The fluorescence R in the present embodiment corresponds to an example of “third light in a third wavelength band” in the present disclosure.

In the present embodiment, the fluorescence G resulting from the conversion by the phosphor layer 52 is not directly emitted from the phosphor layer 52 but enters the auxiliary light-emitting layer 53. That is, part of the fluorescence G enters the auxiliary light-emitting layer 53. The auxiliary light-emitting layer 53 converts the fluorescence G incident from the phosphor layer 52 into the fluorescence R in the third wavelength band and emits the fluorescence R.

The reflective layer 54 is arranged between the auxiliary light-emitting layer 53 and the substrate 51. The reflective layer 54 is formed of a metal film such as silver having a high light reflectance, a dielectric multilayer film, or a combination of these films, and reflects light incident from the auxiliary light-emitting layer 53.

The reflective layer 54 reflects, toward the phosphor layer 52 side, the fluorescence R that traveled mainly in the auxiliary light-emitting layer 53 toward the side opposite to the light incident side (the phosphor layer 52 side). The reflective layer 54 may reflect the excitation light E and the fluorescence G that passed through the auxiliary light-emitting layer 53, and the excitation light E and the fluorescence G reflected off the reflective layer 54 is converted into the fluorescence R in the auxiliary light-emitting layer 53.

Based on such a configuration, the wavelength converter 50 according to the present embodiment can function as a reflection-type wavelength converter that emits, from a first surface 52a of the phosphor layer 52 on which the excitation light E is incident, the yellow fluorescence Y containing the green fluorescence G and the red fluorescence R.

However, the phosphor generates heat when generating the fluorescence, and there is a problem that the fluorescence conversion efficiency decreases and the fluorescence emission amount decreases when the temperature becomes too high. Quantum dots also have a problem that the amount of fluorescence emission decreases due to heat, as in the case of phosphors.

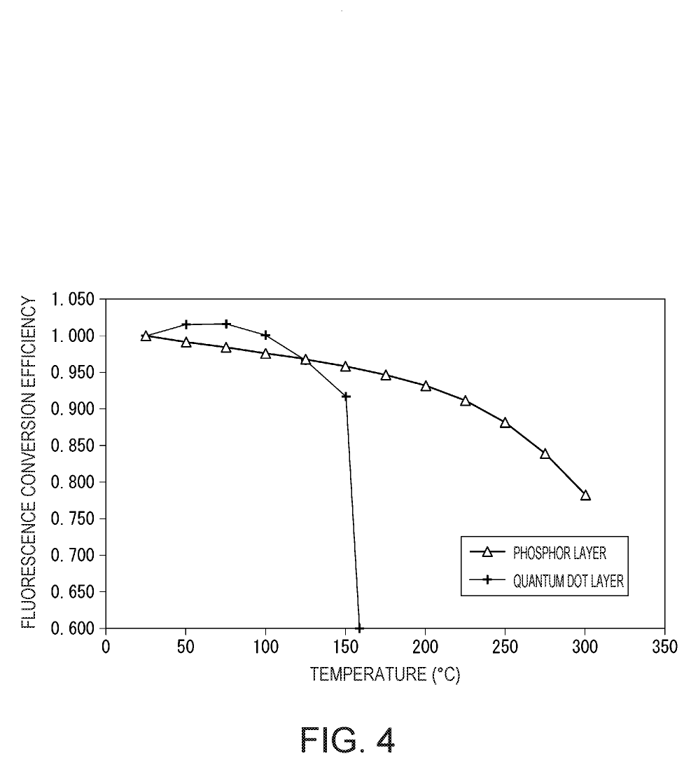

FIG. 4 is a graph showing temperature characteristics of fluorescence conversion efficiency of a phosphor and quantum dots. In FIG. 4, the horizontal axis represents temperature (unit: °C), and the vertical axis represents fluorescence conversion efficiency. Note that FIG. 4 is a graph comparing temperature characteristics of, for example, a YAG-based phosphor layer and an InP-based quantum dot layer, and the fluorescence conversion efficiency on the vertical axis is defined by a relative value when the fluorescence conversion efficiency at room temperature is 1.

As shown in FIG. 4, the fluorescence conversion efficiency of the quantum dots is higher than that of the phosphor from the room temperature to about 100°C, but the fluorescence conversion efficiency of the quantum dots is lower than that of the phosphor at a temperature exceeding 125°C. Therefore, it was confirmed from the graph of FIG. 4 that it is important to set the temperature environment of the quantum dots to be lower than the temperature environment of the phosphor in order to increase the fluorescence conversion efficiency of the quantum dots.

In the wavelength converter 50 according to the present embodiment, the phosphor layer 52 is arranged on the side on which the excitation light E is incident, and the auxiliary light-emitting layer 53 is arranged on the side of the phosphor layer 52 opposite to the side on which the excitation light E is incident. Therefore, since the excitation light E is incident on the auxiliary light-emitting layer 53 after passing through the phosphor layer 52, the light density of the excitation light E incident on the auxiliary light-emitting layer 53 can be suppressed to be small.

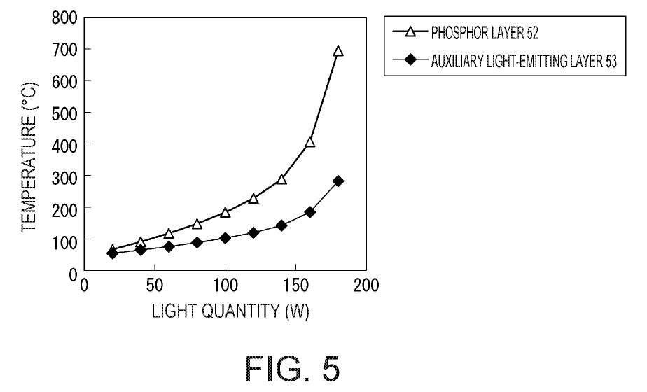

FIG. 5 is a graph showing the temperature conditions of the phosphor layer 52 and the auxiliary light-emitting layer 53 when the excitation light E is irradiated. In FIG. 5, the horizontal axis represents the light amount (unit: W) of the excitation light E, and the vertical axis represents the temperature (unit: °C).

As shown in FIG. 5, in the wavelength converter 50 according to the present embodiment, when the light intensity of the excitation light E is the same, the temperature of the phosphor layer 52 is always higher than the temperature of the auxiliary light-emitting layer 53. For example, when the light amount of the excitation light E is 100 W, the temperature of the phosphor layer 52 is 184°C, whereas the temperature of the auxiliary light-emitting layer 53 is 103°C.

That is, in the wavelength converter 50 according to the present embodiment, the auxiliary light-emitting layer 53 is arranged on the side opposite to the side on which the excitation light E is incident with respect to the phosphor layer 52, whereby the temperature rise of the auxiliary light-emitting layer 53 can be suppressed.

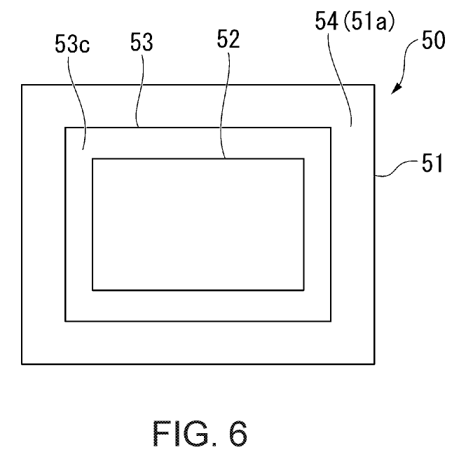

FIG. 6 is a plan view of the wavelength converter 50. FIG. 6 is a plan view of the substrate 51 as viewed from the normal direction. Here, the normal line direction of the substrate 51 is a direction orthogonal to the support surface 51a of the substrate 51.

In the wavelength converter 50 according to the present embodiment, as shown in FIG. 6, the planar size of the auxiliary light-emitting layer 53 is larger than the planar size of the phosphor layer 52. Therefore, the auxiliary light-emitting layer 53 has an projecting section 53c projects from the phosphor layer 52. In the present embodiment, the adhesive layer 55 does not cover the entire front face 53a of the auxiliary light-emitting layer 53 but is provided only in a gap portion between the front face 53a and the phosphor layer 52 and exposes the projecting section 53c. The entire phosphor layer 52 overlaps the auxiliary light-emitting layer 53. In particular, the entire second surface 52b of a phosphor layer 52 is arranged to face the auxiliary light-emitting layer 53 via the adhesive layer 55.

According to this configuration, heat that is transferred from the phosphor layer 52 to the auxiliary light-emitting layer 53 is transferred to the projecting section 53c. The projecting section 53c, which consists of the front face 53a of the auxiliary light-emitting layer 53, is not covered by the adhesive layer 55, and therefore, the projecting section 53c is exposed to the outside air. Thus, the projecting section 53c can efficiently radiate heat into the outside air.

Therefore, according to the wavelength converter 50 of the present embodiment, since the auxiliary light-emitting layer 53 includes the projecting section 53c, it is possible to improve the heat dissipation property of the phosphor layer 52 compared to the case where the planar sizes of the phosphor layer 52 and the auxiliary light-emitting layer 53 are the same.

The wavelength converter 50 according to the present embodiment can generate bright fluorescence G by effectively suppressing temperature rise of the phosphor layer 52 to increase the conversion efficiency of the phosphor layer 52 for the fluorescence G.

The heat of the auxiliary light-emitting layer 53 generated by the emission of the fluorescence R is released mainly via the substrate 51. The auxiliary light-emitting layer 53 of the present embodiment releases heat from the projecting section 53c, and thus has high heat dissipation properties. In the wavelength converter 50 of the present embodiment, the planar size of the support surface 51a of the substrate 51 is larger than the planar size of the auxiliary light-emitting layer 53. Thus, heat of the auxiliary light-emitting layer 53 is efficiently released by spreading from the rear face 53b in the surface direction of the substrate 51.

Therefore, according to the wavelength converter 50 of the present embodiment, the temperature rise of the auxiliary light-emitting layer 53, which is more likely to be affected by the fluorescence conversion efficiency due to the temperature than the phosphor layer 52, is effectively suppressed, whereby the conversion efficiency of the fluorescence R of the auxiliary light-emitting layer 53 is enhanced, whereby bright fluorescence R can be generated.

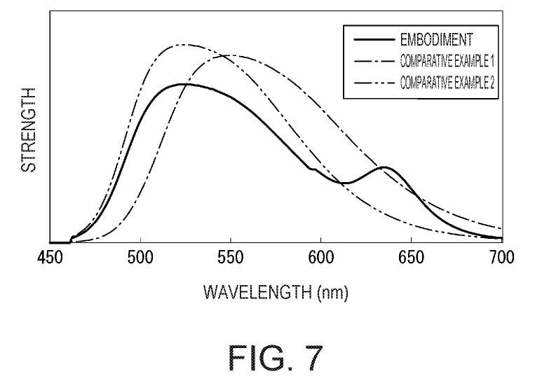

FIG. 7 is a graph showing the emission spectrum of the fluorescence Y outputted from the wavelength converter 50. In FIG. 7, the emission spectrum of the YAG phosphor is indicated by single-dot chain line as a comparative example 1, and the emission spectrum of only the phosphor layer 52 is indicated by two-dot chain line as a comparative example 2. In FIG. 7, the horizontal axis represents wavelength (unit: nm) and the vertical axis represents intensity of the emission spectrum.

As shown in FIG. 7, the component in the green wavelength band included in the emission spectrum of the yellow fluorescence emitted by the YAG phosphor of the comparative example 1 is small. Therefore, in a case where the color purity of the projection image is increased in the projector using the yellow fluorescence, it is necessary to cut the red component by a filter in accordance with the green component having a small light amount, and there is a problem that the brightness of the projection image is reduced.

In contrast, the fluorescence G emitted by the phosphor layer 52 formed of the LuAG phosphor of the comparative example 2 is shifted to the shorter wavelength side than the emission spectrum of the fluorescence emitted by the YAG phosphor of the comparative example 1, and therefore contains a large amount of the component of the green wavelength band. However, the fluorescence G outputted from the phosphor layer 52 has an insufficient amount of light in the red wavelength band. Therefore, in the case of increasing the color purity of the projection image in the projector using the fluorescence G, it is necessary to cut the green component in accordance with the red component having a small light amount, and there is a problem that the brightness of the projection image is reduced.

In contrast, the fluorescence Y outputted by the wavelength converter 50 in the present embodiment, which is the fluorescence R emitted from the auxiliary light-emitting layer 53, can compensate for the component in the red wavelength band compared with the fluorescence G in the comparative example 2. It should be noted that since the fluorescence G generated in the phosphor layer 52 is converted into the fluorescence R in the auxiliary light-emitting layer 53, the intensity of the fluorescence Y in the green wavelength band becomes lower than that in the light emission spectrum in the comparative example 2.

As described above, the wavelength converter 50 according to the present embodiment includes a substrate 51; the phosphor layer 52 arranged on the substrate 51 converts the incident excitation light E in the first wavelength band to fluorescence G in the second wavelength band; the auxiliary light-emitting layer 53, which is arranged between the phosphor layer 52 and the substrate 51, contains a plurality of quantum dots 530, and converts part of the excitation light E that passed through the phosphor layer 52 and part of the fluorescence G converted by the phosphor layer 52 into fluorescence R in a third wavelength band that overlaps with a portion of the second wavelength band; and the reflective layer 54, which is disposed between the auxiliary light-emitting layer 53 and the substrate 51, reflects light incident from the auxiliary light-emitting layer 53. In plan view from the normal direction of the substrate 51, the planar size of the auxiliary light-emitting layer 53 is larger than the planar size of the phosphor layer 52, and the entire phosphor layer 52 overlaps the auxiliary light-emitting layer 53.

The wavelength converter 50 according to the present embodiment can output the fluorescence Y containing the fluorescence R outputted from the auxiliary light-emitting layer 53 and the fluorescence G outputted from the phosphor layer 52. The fluorescence Y can be used as illumination light having an expanded color gamut of the red component because the red component lacking in the fluorescence G is supplemented by the fluorescence R.

In the wavelength converter 50 according to the present embodiment, the auxiliary light-emitting layer 53 is arranged at the opposite side of the phosphor layer 52 than the side on which the excitation light E is incident, whereby an increase in the temperature of the auxiliary light-emitting layer 53 can be suppressed. Since the auxiliary light-emitting layer 53 is arranged in a state of protruding from the phosphor layer 52, the auxiliary light-emitting layer 53 can efficiently release heat that is transferred from the phosphor layer 52 via the projecting section 53c. Therefore, the wavelength converter 50 of the present embodiment can improve the heat dissipation of the phosphor layer 52 compared to the case where the planar sizes of the phosphor layer 52 and the auxiliary light-emitting layer 53 are the same. The phosphor layer 52 can therefore have improved fluorescence conversion efficiency and generate bright fluorescence G. The auxiliary light-emitting layer 53 efficiently releases heat from the projecting section 53c projecting from the phosphor layer 52, and therefore has high heat dissipation properties.

Therefore, according to the wavelength converter 50 of the present embodiment, it is possible to increase the conversion efficiency of the fluorescence R of the auxiliary light-emitting layer 53 and generate bright fluorescence R by improving the heat dissipation of the auxiliary light-emitting layer 53, the fluorescence conversion efficiency of which is easily affected by heat.

The wavelength converter 50 according to the present embodiment can therefore output the fluorescence Y, which excels in heat dissipation and has an expanded color gamut.

Since the wavelength converter 50 according to the present embodiment is a fixed-type wavelength converter in which the position where the excitation light E is incident on the phosphor layer 52 does not change with time, the phosphor layer 52 and the auxiliary light-emitting layer 53 are more likely to have high temperatures than in a rotary-type wavelength converter in which the position where the excitation light E is incident on the phosphor layer 52 changes with time. In contrast, the wavelength converter 50 according to the present embodiment emits the fluorescence Y having an expanded color gamut due to the improved heat dissipation from the auxiliary light-emitting layer 53 so a configuration that more significantly achieves the effects of the present disclosure can be achieved.

The light source device 2 according to the present embodiment includes the wavelength converter 50 described above and the first light source 40, which outputs the excitation light E toward the wavelength converter 50.

According to the light source device 2 of the present embodiment, since it is provided with the wavelength converter 50, which outputs the fluorescence Y containing a sufficient amount of the red component, it can generate the illumination light WL having high color purity by making up for the shortage of the red component.

The projector 1 according to the present embodiment includes the light source device 2 described above, the light modulation devices 4R, 4G, and 4B, which modulate the illumination light WL containing the fluorescence G and the fluorescence R outputted from the light source device 2 in accordance with image information, and the projection optical device 6, which projects the light that was modulated by the light modulation devices 4R, 4G, and 4B.

According to the projector 1 of the present embodiment, since the light source device 2 described above is provided, it can modulate the white illumination light WL with high color purity by sufficiently compensating for the red color component and project an image. The projector 1 that displays a bright and high-quality image can therefore be provided.

The technical scope of the present disclosure is not limited to the above embodiments, and various modifications can be made without departing from the spirit of the present disclosure.

For example, the auxiliary light-emitting layer 53 of the above embodiment is formed of a film layer, but the configuration of the auxiliary light-emitting layer is not limited to this. For example, a structure in which the plurality of quantum dots 530 are dispersed in a binder may be employed.

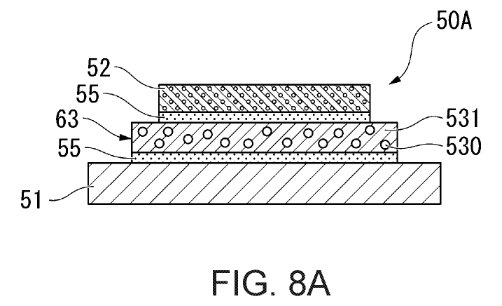

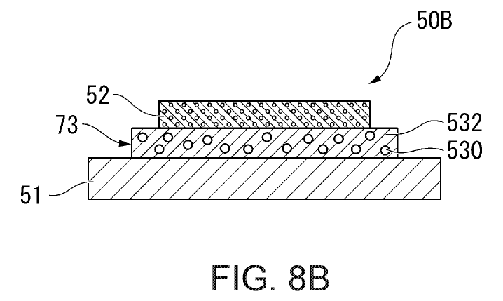

FIGS. 8A and 8B are diagrams showing cross-sectional structures of wavelength converter having auxiliary light-emitting layer according to modifications.

An auxiliary light-emitting layer 63 of a wavelength converter 50A shown in the FIG. 8A has a structure in which the plurality of quantum dots 530 are dispersed in a binder 531 made of a translucent inorganic material. As the inorganic material constituting the binder 531, for example, inorganic glass can be used.

According to the auxiliary light-emitting layer 63 having this configuration, since the binder 531 is formed of an inorganic material, the heat resistance of the auxiliary light-emitting layer 63 can be improved. The heat dissipation of the auxiliary light-emitting layer 63 can be improved. The auxiliary light-emitting layer 63 is formed by sintering an inorganic material in which the plurality of quantum dots 530 are dispersed. The auxiliary light-emitting layer 63 is bonded to the reflective layer 54 and the phosphor layer 52 via the adhesive layer 55.

An auxiliary light-emitting layer 73 of a wavelength converter 50B shown in FIG. 8B has a structure in which the plurality of quantum dots 530 are dispersed in a binder 532 made of a resinous material. As the resin material constituting the binder 532, for example, an epoxy resin or the like can be used. The auxiliary light-emitting layer 73 is formed by applying a resin in which the plurality of quantum dots 530 are dispersed on the reflective layer 54 and then curing the resin in a state where the phosphor layer 52 is placed on the resin.

According to the auxiliary light-emitting layer 73 having this configuration, since the binder 532 is formed of a resin material, the binder 532 itself can be used as an adhesive layer for adhering the reflective layer 54 and the phosphor layer 52. Therefore, the adhesive layer 55 used in the auxiliary light-emitting layer 53 of the above embodiment and the auxiliary light-emitting layer 63 in the FIG. 8A can be omitted, and thus the number of components can be reduced.

In the embodiments described above, there is shown the example in which the light source device according to the present disclosure is mounted on the projector, but the present disclosure is not limited to this example. The light source device according to the present disclosure can also be applied to a lighting fixture, a headlight of an automobile, and the like.

Although the wavelength converter 50 in the embodiment described above is exemplified by a fixed type wavelength converter in which the position where the excitation light E enters the phosphor layer 52 does not change with time, the present disclosure is also applicable to a rotary-type wavelength converter in which the position where the excitation light E enters the phosphor layer 52 changes with time.

### Summary of the present disclosure

Hereinafter, an outline of the present disclosure is appended.

### First appendix

A wavelength converter includes: a substrate; a phosphor layer arranged on the substrate and configured to convert incident first light in a first wavelength band into second light in a second wavelength band that is different from the first wavelength band; an auxiliary light-emitting layer that is arranged between the phosphor layer and the substrate, that includes a plurality of quantum dots, and that is configured to convert a portion of the first light transmitted through the phosphor layer and a portion of the second light converted by the phosphor layer into third light in a third wavelength band that is different from the first wavelength band and that partially overlaps the second wavelength band; and a reflective layer that is arranged between the auxiliary light-emitting layer and the substrate and that is configured to reflect light incident from the auxiliary light-emitting layer, wherein as viewed in plan view from a normal direction of the substrate, the auxiliary light-emitting layer has a larger planar size than that of the phosphor layer, and the entire phosphor layer overlaps the auxiliary light-emitting layer.

According to the wavelength converter having this configuration, it is possible to emit light including the third light emitted from the auxiliary light-emitting layer and the second light emitted from the phosphor layer. The light outputted from the wavelength converter therefore has an expanded color gamut because the third light supplements the component in the third wavelength band that is deficient in the second light.

In the wavelength converter, the auxiliary light-emitting layer is disposed on the opposite side of the phosphor layer from the incident side of the first light, whereby the temperature rise of the auxiliary light-emitting layer can be suppressed. Since the auxiliary light-emitting layer is arranged in a state of projecting out from the phosphor layer, the auxiliary light emitting layer can efficiently release the heat transmitted from the phosphor layer via the projecting section. Therefore, the wavelength converter can improve the heat dissipation of the phosphor layer as compared with the case where the phosphor layer and the auxiliary light-emitting layer have the same planar size. This improves the fluorescence conversion efficiency of the phosphor layer, and bright fluorescence can be generated. The auxiliary light-emitting layer efficiently releases its own heat from the projecting section, and therefore has high heat dissipation properties.

Therefore, according to the wavelength converter having this configuration, the conversion efficiency of the auxiliary light-emitting layer can be increased by improving the heat dissipation of the auxiliary light-emitting layer that is easily affected by the fluorescence conversion efficiency due to heat, and the bright third light can be generated.

Therefore, according to the wavelength converter having this configuration, it is possible to emit light having excellent heat dissipation properties and an expanded color gamut.

### Second appendix

The wavelength converter, according to the first appendix, wherein the phosphor layer is a green light emitting phosphor and the auxiliary light-emitting layer emits red light as the third light.

According to this configuration, the phosphor layer formed of the green light emitting phosphor emits the fluorescence containing a larger amount of the green component than the yellow-emitting phosphor. The red component that is insufficient in the fluorescence emitted by the green light emitting phosphor can be compensated by the red light emitted from the auxiliary light-emitting layer. Therefore, the wavelength converter having this configuration can generate light having high color purity.

### Third appendix

The wavelength converter according to the first appendix or the second appendix, wherein the auxiliary light-emitting layer is bonded to the reflective layer and the phosphor layer via an adhesive layer.

According to this configuration, the wavelength converter can be easily manufactured.

### Fourth appendix

The wavelength converter, according to any one of the first to the third appendices, wherein the auxiliary light-emitting layer further includes a binder in which the plurality of quantum dots are dispersed and the binder is made of a translucent inorganic material.

According to this configuration, since the binder is formed of an inorganic material, the heat resistance and heat dissipation of the auxiliary light-emitting layer can be improved.

### Fifth appendix

The wavelength converter wherein according to any one of the first to the fourth appendices, wherein the phosphor layer includes a plurality of voids and a volume percentage of the voids is 3 vol% or less in terms of volume ratio to the entire phosphor layer.

According to this configuration, since the light is appropriately scattered inside the phosphor layer, it is possible to suppress an expansion in the light emitting area of the phosphor layer due to the light excessively spreading in the plane direction inside the phosphor layer. Therefore, the etendue of the light emitted from the phosphor layer can be reduced, and the light loss in the optical component disposed in the subsequent stage of the phosphor layer can be reduced.

### Sixth appendix

The wavelength converter according to any one of the first to the fifth appendices, wherein the phosphor layer has a thickness of 200 μm or less, and concentration of activator in the phosphor layer is 1 mol% or less.

According to this configuration, a sufficient amount of excitation light can be incident on the auxiliary light-emitting layer.

### Seventh appendix

The wavelength converter according to any one of the first to the sixth appendices, wherein the third wavelength band of the third light is in the range of 600 to 700 nm.

According to this configuration, it is possible to generate light that compensates for the 600 to 700 nm wavelength band, which is insufficient in the yellow fluorescence.

### Eighth appendix

The wavelength converter according to any one of the first to the seventh appendices, wherein an incident position of the first light on the phosphor layer remains constant over time.

In the case where the incident position of the first light does not change with time, the phosphor layer and the auxiliary light-emitting layer in contact with the phosphor layer are more likely to have a high temperature than in the case where the incident position of the first light changes with time. In contrast, according to the wavelength converter having this configuration, since it emits the fluorescence Y having an expanded color gamut due to the improved heat dissipation of the auxiliary light-emitting layer, a configuration that more significantly achieves the effects of the disclosure can be realized.

### Ninth appendix

A light source device includes: a lighting source that emits the first light and the wavelength converter according to any one of the first to eighth appendixes, on which the first light emitted from the lighting source is incident.

According to this configuration, since the wavelength converter that emits the light including the third wavelength band is provided, it is possible to generate the illumination light having high color purity by compensating for the shortage of the third wavelength band.

### Tenth appendix

A projector includes: a light source device according to the ninth appendix; a light modulation device that modulates light including the second light and the third light emitted from the light source device in accordance with image information; and a projection optical device that projects the light that was modulated by the light modulation device.

According to the projector having this configuration, since the above-described light source device is provided, it is possible to modulate the illumination light having high color purity and project an image. Therefore, it is possible to provide a projector which displays a bright and high-quality image.

What is claimed is:

1. A wavelength converter comprising:
a substrate;
a phosphor layer arranged on the substrate and configured to convert incident first light in a first wavelength band into second light in a second wavelength band that is different from the first wavelength band;
an auxiliary light-emitting layer that is arranged between the phosphor layer and the substrate, that includes a plurality of quantum dots, and that is configured to convert a portion of the first light transmitted through the phosphor layer and a portion of the second light converted by the phosphor layer into third light in a third wavelength band that is different from the first wavelength band and that partially overlaps the second wavelength band; and
a reflective layer that is arranged between the auxiliary light-emitting layer and the substrate and that is configured to reflect light incident from the auxiliary light-emitting layer, wherein
as viewed in plan view from a normal direction of the substrate,
the auxiliary light-emitting layer has a larger planar size than that of the phosphor layer, and the entire phosphor layer overlaps the auxiliary light-emitting layer.

2. The wavelength converter according to claim 1, wherein
the phosphor layer is a green light emitting phosphor and
the auxiliary light-emitting layer emits red light as the third light.

3. The wavelength converter according to claim 1, wherein
the auxiliary light-emitting layer is film-shaped and is bonded to both the reflective layer and the phosphor layer via an adhesive layer.

4. The wavelength converter according to claim 1, wherein
the auxiliary light-emitting layer further includes a translucent inorganic binder in which a plurality of quantum dots are dispersed.

5. The wavelength converter according to claim 1, wherein
the phosphor layer includes a plurality of voids and
a volume percentage of the voids is 3 vol% or less in terms of volume ratio to the entire phosphor layer.

6. The wavelength converter according to claim 1, wherein
the phosphor layer has a thickness of 200 μm or less, and concentration of activator in the phosphor layer is 1 mol% or less.

7. The wavelength converter according to claim 1, wherein
the third wavelength band of the third light is in the range of 600 to 700 nm.

8. The wavelength converter according to claim 1, wherein
an incident position of the first light on the phosphor layer remains constant over time.

9. A light source device comprising:
a lighting source that emits the first light and
the wavelength converter according to claim 1, wherein the first light emitted from the lighting source is incident on the wavelength converter.

10. A projector comprising:
the light source device according to claim 9;
a light modulation device that modulates light including the second light and the third light emitted from the light source device in accordance with image information; and
a projection optical device that projects the light that was modulated by the light modulation device.
